(19) United States
(12) Patent Application Publication
(10) Pub. No.: US 2024/0338558 A1
(43) Pub. Date: Oct. 10, 2024

(54) ADAPTIVE BUFFER MANAGEMENT TO SUPPORT DYNAMIC TENSOR SHAPE IN DEEP NEURAL NETWORK APPLICATIONS

(71) Applicant: Intel Corporation, Santa Clara, CA (US)

(72) Inventor: Liyang LING, Shanghai (CN)

(73) Assignee: Intel Corporation, Santa Clara, CA (US)

(21) Appl. No.: 18/574,903

(22) PCT Filed: Dec. 6, 2021
(86) PCT No.: PCT/CN2021/135667

§ 371 Date: Dec. 28, 2023

(51) Int. Cl. G06N 3/08

(52) U.S. Cl. CPC G06N 3/08

(57) ABSTRACT

The disclosure relates to adaptive buffer management to support a dynamic tensor shape in a DNN. An apparatus for the DNN may include processor circuitry configured to: determine whether a tensor shape of an input tensor of an object in the DNN is dynamic and exists in a shape buffer pool; run the object by use of a compilation result for the object stored in the shape buffer pool when the tensor shape of the input tensor is dynamic and exists in the shape buffer pool; and invoke the compilation procedure to perform JIT compilation for the object so as to get the compilation result for the object when the tensor shape of the input tensor is dynamic and does not exist in the shape buffer pool.

### TECHNICAL FIELD

Embodiments described herein generally relate to the field of neural network, and more particularly relate to adaptive buffer management to support a dynamic tensor shape in deep neural network (DNN) applications.

### BACKGROUND

DNNs are powerful learning models that achieve state-of-the-art performance on many complex tasks such as computer vision, speech, and language processing. The DNNs include an input layer, an output layer and at least one hidden layer in between and use sophisticated mathematical modeling to process data transferred among these network layers to provide solutions for complex tasks. The data in the DNNs may be represented as a variety of tensors. As quick development and wide usage of DNNs, artificial intelligence (AI) solutions and applications emerge in various areas and this trend will continue to go even faster than what we can see. Thus the data to be processed in the DNNs may be more and more complex and represented as various types of tensors.

### BRIEF DESCRIPTION OF THE DRAWINGS

The various advantages of the embodiments will become apparent to one skilled in the art by reading the following specification and appended claims, and by referencing the following drawings, in which:

FIG. 1 shows a schematic flowchart of a typical compilation procedure of an Intermediate Representation (IR) based deep learning compiler for a DNN in accordance with embodiments of the present disclosure;

FIG. 2 shows a schematic flowchart of a compilation procedure evolved from the compilation procedure in FIG. 1 to support a dynamic tensor shape for DNN applications in accordance with embodiments of the present disclosure;

FIG. 3 shows a schematic flowchart of a runtime procedure on basis of the compilation procedure in FIG. 2 to support a dynamic tensor shape for DNN applications in accordance with embodiments of the present disclosure;

FIG. 4 shows a schematic flowchart of an overall compilation and runtime procedure with adaptive buffer management to support a dynamic tensor shape for DNN applications in accordance with embodiments of the present disclosure;

FIG. 5 is a block diagram illustrating components, according to some example embodiments, able to read instructions from a machine-readable or computer-readable medium and perform any one or more of the methodologies discussed herein; and

FIG. 6 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

As the quick development and wide usage of DNNs, AI solutions and applications emerge in various areas and this trend will continue to go even faster than what we can see. The data to be processed in the DNNs may be more and more complex and represented as various types of tensors including tensors with static tensor shapes or dynamic tensor shapes. However, till now, the dynamic tensor shape problem has always been one of serious problems hindering many actual business landing.

Most deep learning frameworks in industry, including Accelerated Linear Algebra (XLA), are static tensor shape semantic based compiler frameworks. It means before deploying and touching input data, the DNN is aware of exact shapes of tensors at each network layer. The benefit is obvious. With known tensor shapes, a tensor compiler for the DNN can make decision easily to optimize and generate more effective codes, and can also make optimized plans for scheduling and memory management.

However, the fact is in actual production scenarios, especially in object detection and natural language processing (NLP) tasks, a tensor shape of an input tensor for an object in a network layer is usually unfixed, which would block a common compilation process or be too effort-consuming to meet business requirement.

For example, one reason for the dynamic tensor shape problem may be a neural network program can only touch tensor values inside input tensors at runtime, but the compiler need to create buffer spaces for those tensors when building computation graphs at compiling time. There are many DNN operations whose output tensors depend on the tensor values of their input tensors which are unavailable at the compiling time. As a result, the tensor shapes of the output tensors of these DNN operations are unknown to the compiler at the compiling time. Further, the output tensors of these DNN operations may be used as input tensors of other DNN operations (e.g. DNN operations in another network layer). It means that the tensor shapes of the input tensors of those DNN operations in another network layer are also unknown to the compiler at the compiling time. Therefore, the dynamic tensor shape problem is a common problem in the DNNs, and an effective strategy to the dilemma of dynamic tensor shapes will accelerate the AI production promotion.

To avoid the influence from dynamic tensor shapes, network layer adjustments may be made. A common strategy is to transform tensors with dynamic tensor shapes to tensors with a fixed tensor shape. For example, for a NLP task, a simple solution is to pad or crop the input tensors to restrict all the input tensors to have a predefined tensor shape. For an object detection task, there may be more solutions, and one typical way is interpolation. For example, the solution may include calculating a weighted average of a target pixel's neighbors and resizing the input tensors to have a desired tensor shape by interpolation.

The disadvantage of the network layer adjustments is that the adjustments from network structures cannot solve the problem of dynamic tensor shapes fundamentally. The solution is more like a workaround to help DNN programs work. Regardless of cropping, padding or interpolation being performed for the input tensors, complete input information contained in the input tensors cannot be kept perfectly, and thus a user has to tolerate precision loss to some extent. Also, it is a problem to determine an appropriate fixed tensor shape as a hyper parameter when defining the networks.

On the other hand, for most static tensor shape semantic based compiler frameworks, a traditional way to deal with dynamic information is to perform Just-in-time compilation. Specifically, when building computation graphs from networks at a compilation stage, the compiler may create small blocks for those layers which may potentially have input tensors with dynamic tensor shapes. At runtime, those blocks may be rebuilt based on input data and decided tensor shapes. The main disadvantage of the solution based on JIT compilation is about performance. Using JIT compilation may increase the workload of compilation. For training tasks, high compilation workload may cause unstable training iterations and result in unacceptable time cost of the training process. For inference tasks, performance fluctuation is not allowed in most real-time business.

In view of the above issues, according to embodiments of the present disclosure, a compilation and runtime procedure with adaptive buffer management is proposed to deal with the dilemma of dynamic tensor shapes for the deep learning compilers of the DNNs.

Generally, the proposed compilation and runtime procedure is based on adaptive buffer management by use of a shape buffer pool which is configured to store compilation results for a set of predetermined tensor shapes and associated objects. The set of predetermined tensor shapes and associated objects may be a group of most common tensor shapes and their associated objects. The compilation results for the set of tensor shapes and their associated objects can be cached in the shape buffer pool to be reused at runtime as appropriate instead of recompiling the associated objects each time. Meanwhile, the shape buffer pool can be updated by applying a least recently used (LRU) algorithm to remove a compilation result for an unpopular tensor shape, so as to guarantee the size of the shape buffer pool will not grow too big.

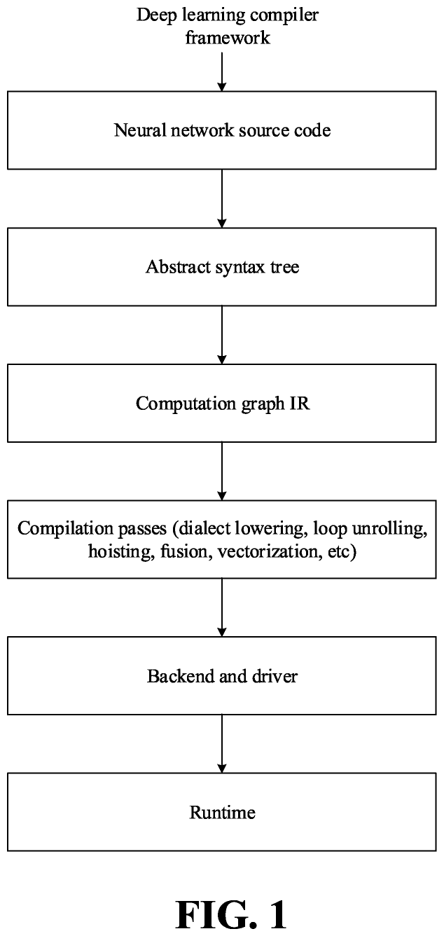

The compilation and runtime procedure according to embodiments of the present disclosure will be described in detail below with reference to FIG. 1 to FIG. 4.

FIG. 1 shows a schematic flowchart of a typical compilation procedure of an IR based deep learning compiler for a DNN in accordance with embodiments of the present disclosure. As shown in FIG. 1, the compilation procedure can be implemented by a compiler based on a multi-level IR architecture for the DNN, and may include generation of abstract syntax tree, generation of computation graph IR, compilation passes for IR lowering and optimization, and configuration of backend and drivers. The compilation passes for IR lowering and optimization may include typical IR lowering and optimization passes such as dialect lowering, loop unrolling, hoisting, fusion, vectorization, etc, and after the configuration of backend and drivers, binary codes specific to a device may be generated for execution by the device.

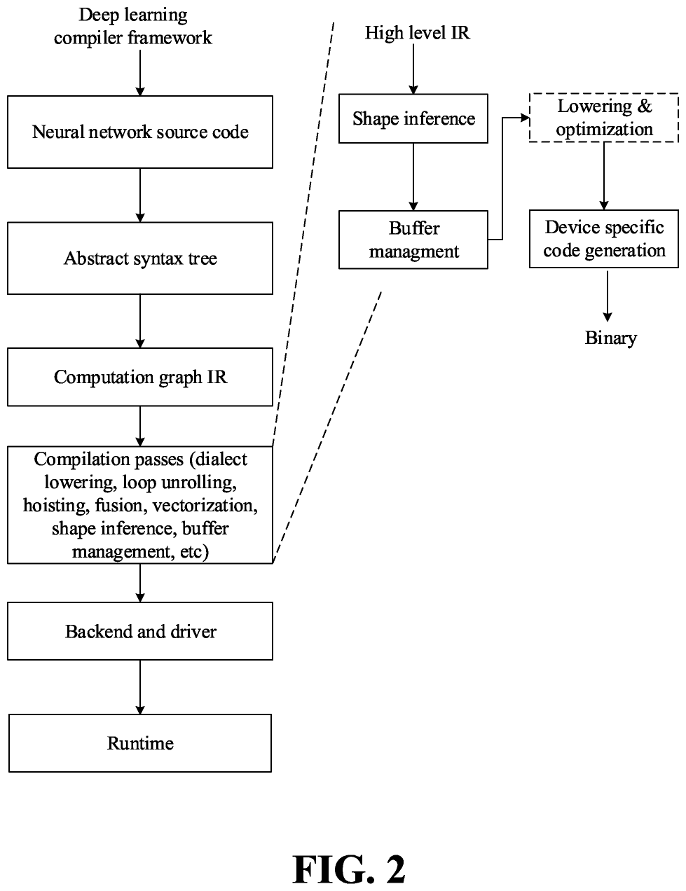

According to embodiments of the present disclosure, in order to deal with the dilemma of dynamic tensor shapes for deep learning compilers of the DNNs, the compilation procedure in FIG. 1 may be modified by adding two passes in the IR lowering procedure. FIG. 2 shows a schematic flowchart of a compilation procedure evolved from the compilation procedure in FIG. 1 to support a dynamic tensor shape for a DNN in accordance with embodiments of the present disclosure. Likewise, the compilation procedure in FIG. 2 can be also implemented by a compiler based on the multi-level IR architecture for the DNN. Compared with the compilation procedure in FIG. 1, the compilation procedure in FIG. 2 includes two additional passes in the IR lowering procedure.

The first added pass may be referred to as a shape inference pass, which may generate a new dialect called “buffer dialect” from a static tensor shape based high level IR. The buffer dialect may be configured to define representations of one or more types of tensors with either static or dynamic tensor shapes, operations associated with the tensors, and attributes associated with the operations. Generally, tensors in a network layer can be divided into four categories: 1) known shape, known rank; 2) partially unknown shape, known rank; 3) completely unknown shape, known rank; 4) unknown shape, unknown rank. The proposed buffer dialect may be applied to provide representations for at least tensors of the above categories 2) and 3). In other words, the tensors in the buffer dialect may have a dynamic tensor shape and a static rank.

For example, for tensors with a static shape and a static rank, the representation of an input tensor and an output tensor for an object in a network layer may be tensor<16x16xf32>-->tensor<16x16xf32>. In the new buffer dialect, tensors with either static shapes or dynamic shapes can be represented. For example, the representation of an input tensor and an output tensor for an object in a network layer may be tensor<16x % 1xf32>-->tensor<16x % 1xf32> or tensor<3x3xf32>-->tensor<2x % 2xf32>. In the representation, % 1 and % 2 indicate that the tensor shapes of the tensors are dynamic values. It can be seen that both the input tensor and the output tensor for the object may have dynamic tensor shapes, or the input tensor may have a static tensor shape but the output tensor may have a dynamic tensor shape. In an example, % 1 and % 2 can be Static Single Assignment (SSA) forms calculated from tensor values of corresponding tensors. In other words, the representations of the tensors in the buffer dialect may be based on a SSA form calculated from tensor values of the tensors.

The second added pass may be referred to as a buffer management pass. The buffer management pass may be configured to determine whether a tensor in a current operation of an object needs dynamic buffer according to the representation of the tensor in the buffer dialect. When it is determined the tensor needs dynamic buffer, the buffer management pass may set a tag for the tensor and the object associated with the tensor to indicate the tensor is dynamic and static compilation of the tensor and the associated object is not to be performed. In this case, the compilation of the tensor and the associated object may be performed at the runtime process which will be described below. Otherwise, when it is determined the tensor is a static tensor, the compilation procedure will proceed following the traditional static compilation path.

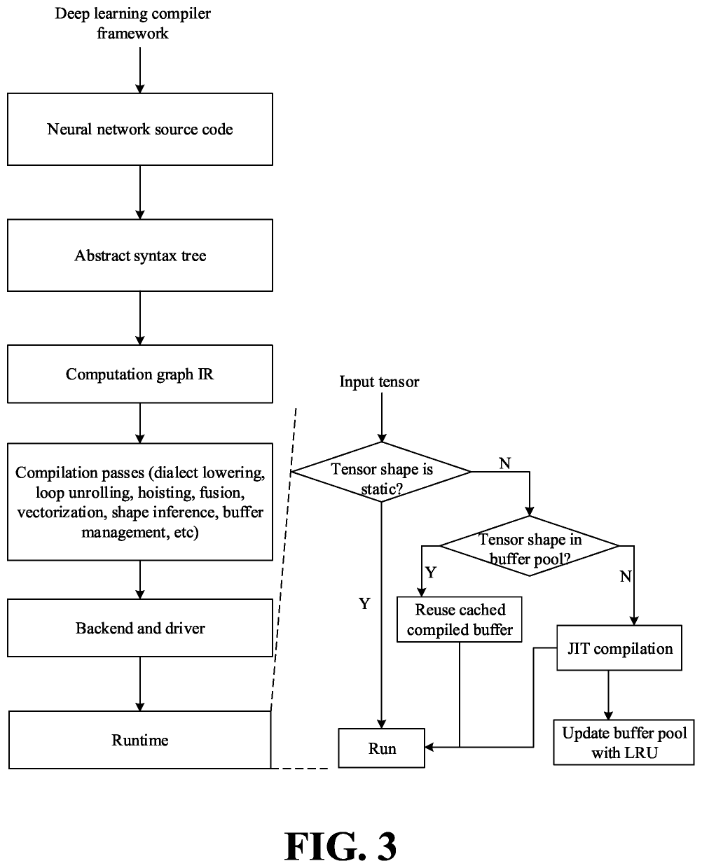

FIG. 3 shows a schematic flowchart of a runtime procedure on basis of the compilation procedure in FIG. 2 to support a dynamic tensor shape for a DNN in accordance with embodiments of the present disclosure. The runtime procedure may be performed by an apparatus for executing models defined by the DNN. The apparatus may perform the runtime procedure based on compilation results obtained by the compilation procedure for the DNN, e.g. the compilation procedure shown in FIG. 2.

As shown in the right part of FIG. 3, at runtime, the apparatus may firstly check if an input tensor of an object has a static tensor shape or a dynamic tensor shape. When the input tensor has a static tensor shape, the apparatus may proceed to run the object by use of a static tensor shape based compilation result for the object (e.g. obtained by the compilation procedure in FIG. 1). Otherwise, when the input tensor has a dynamic tensor shape, the apparatus may further determine whether the tensor shape of the input tensor of the object exists in a shape buffer pool. The shape buffer pool may be configured to store compilation results for a set of predetermined tensor shapes and associated objects. The set of predetermined tensor shapes and associated objects may be a group of most common tensor shapes and their associated objects. When it is determined that the tensor shape of the input tensor of the object exists in the shape buffer pool, the apparatus may run the object by use of a compilation result for the object stored in the shape buffer pool instead of recompiling the object. When it is determined that the tensor shape of the input tensor of the object does not exist in the shape buffer pool, the apparatus may invoke the compilation procedure for the DNN to perform JIT compilation for the object so as to get the compilation result for the object. Then the apparatus may update the shape buffer pool by adding the compilation result for the object obtained by the JIT compilation for the object. Meanwhile, the apparatus may update the shape buffer pool by applying a LRU algorithm to remove a compilation result for an unpopular tensor shape so as to make sure the shape buffer pool always contains compilation results for popular tensor shapes and does not consume too much memory space.

According to the foregoing description, an adaptive buffer management strategy to deal with the dilemma of dynamic tensor shapes for the DNN and thus improve compilation and runtime performance of the DNN has been proposed according to embodiments of the present disclosure. The strategy can reduce JIT compilation workloads and meanwhile can gain better performance especially for inference tasks in the DNN applications.

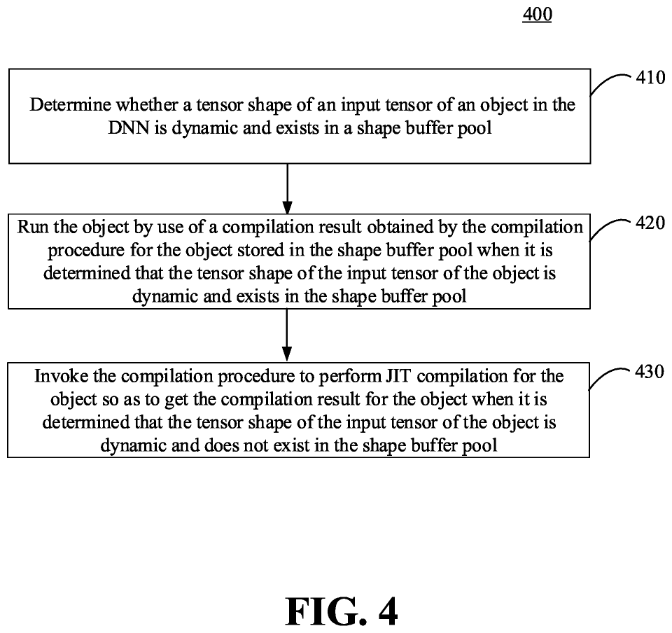

An overall idea of the adaptive buffer management strategy will be further described with reference to FIG. 4, which shows a schematic flowchart of an overall compilation and runtime procedure 400 with adaptive buffer management to support a dynamic tensor shape for a DNN in accordance with embodiments of the present disclosure. The procedure 400 may be performed by a processor circuitry for the DNN and include operations 410 to 430. For example, the processor circuitry may include a compiler based on the multi-level IR architecture for the DNN.

At operation 410, the processor circuitry may determine whether a tensor shape of an input tensor of an object in the DNN is dynamic and exists in a shape buffer pool. The input tensor may be received from a higher network level in a compilation procedure for the DNN. The shape buffer pool may be configured to store compilation results obtained by the compilation procedure for a set of predetermined tensor shapes and associated objects.

Here, the input tensor may represent a logical tensor received from a higher network level in a compilation pipeline for the DNN, compared to an actual tensor with real values received by the DNN. It can be easily understood that when compiling a DNN model, the compiler may know there are tensors that will be taken as input tensors of the DNN model and these tensors may be referred to as logical tensors herein, and when the DNN model is running somewhere to perform actual tasks, actual tensors with real values may be fed into the DNN model according to the design of the model and these tensors may be referred to as actual tensors herein.

At operation 420, the processor circuitry may run the object by use of a compilation result for the object stored in the shape buffer pool when it is determined that the tensor shape of the input tensor of the object is dynamic and exists in the shape buffer pool.

At operation 430, the processor circuitry may invoke the compilation procedure to perform JIT compilation for the object so as to get the compilation result for the object when it is determined that the tensor shape of the input tensor of the object is dynamic and does not exist in the shape buffer pool.

According to some embodiments of the present disclosure, the processor circuitry may update the shape buffer pool by adding the compilation result for the object obtained by the JIT compilation for the object, and update the shape buffer pool by applying a LRU algorithm to remove a compilation result for an unpopular tensor shape.

According to some embodiments of the present disclosure, the processor circuitry may run the object by use of a static tensor shape based compilation result when it is determined that the tensor shape of the input tensor of the object is static.

According to some embodiments of the present disclosure, the compilation procedure may include an IR lowering procedure based on the multi-level IR architecture for the DNN. The IR lowering procedure may include a shape inference pass for generating a buffer dialect from a static tensor shape based high level IR. The buffer dialect may be configured to define representations of one or more types of tensors with either static or dynamic tensor shapes, operations associated with the tensors, and attributes associated with the operations. The IR lowering procedure may further include a buffer management pass configured to: set a tag for a tensor and an object associated with the tensor to indicate the tensor is dynamic and static compilation of the tensor and the associated object is not to be performed, when it is determined the tensor needs dynamic buffer according to the representation of the tensor in the buffer dialect.

According to some embodiments of the present disclosure, the representations of the tensors in the buffer dialect may be based on a SSA form calculated from tensor values of the tensors.

According to some embodiments of the present disclosure, the input tensor may have a static rank.

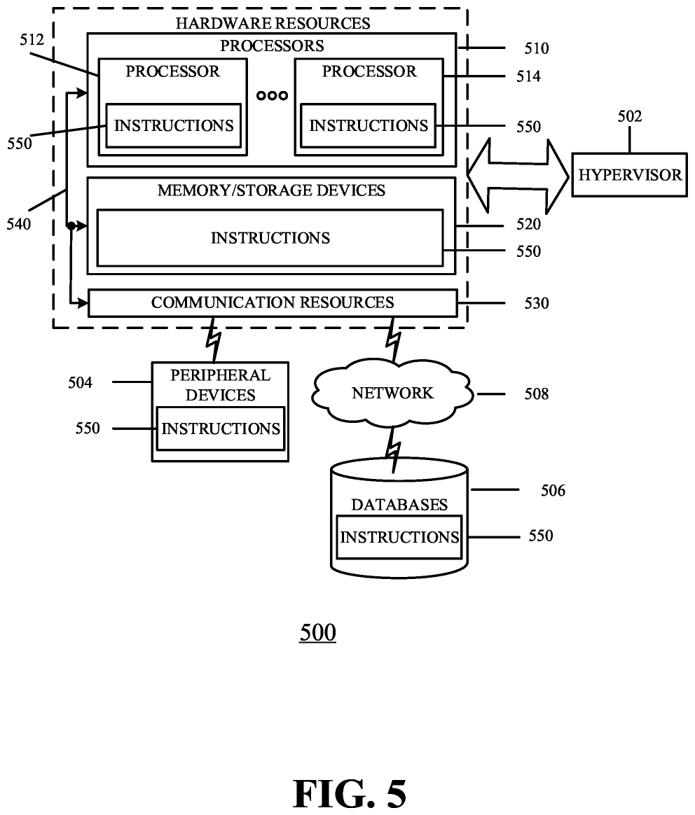

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 520 may include main memory, disk storage, or any suitable combination thereof. The memory/storage devices 520 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 530 may include interconnection or network interface components or other suitable devices to communicate with one or more peripheral devices 504 or one or more databases 506 via a network 508. For example, the communication resources 530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

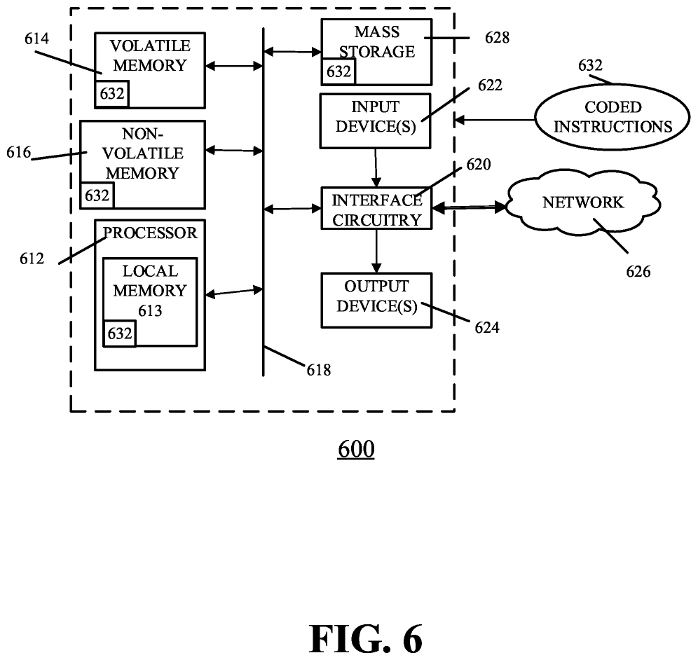

FIG. 6 is a block diagram of an example processor platform in accordance with some embodiments of the disclosure. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes interface circuitry 620. The interface circuitry 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuitry 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 620 of the illustrated example, thus, typically includes a graphics driver card, a graphics driver chip and/or a graphics driver processor.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 620 may include a training dataset inputted through the input device(s) 622 or retrieved from the network 626.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives.

Machine executable instructions 632 may be stored in the mass storage device 628, in the volatile memory 614, in the non-volatile memory 616, and/or on a removable non-transitory computer readable storage medium such as a CD or DVD.

Additional Notes and Examples:

Example 1 includes an apparatus for a deep neural network (DNN), comprising: interface circuitry; and processor circuitry coupled to the interface circuitry and configured to: determine whether a tensor shape of an input tensor of an object in the DNN is dynamic and exists in a shape buffer pool, the input tensor being received via the interface circuitry from a higher network level in a compilation procedure for the DNN, the shape buffer pool being configured to store compilation results obtained by the compilation procedure for a set of predetermined tensor shapes and associated objects; run the object by use of a compilation result for the object stored in the shape buffer pool when it is determined that the tensor shape of the input tensor of the object is dynamic and exists in the shape buffer pool; and invoke the compilation procedure to perform Just-in-time (JIT) compilation for the object so as to get the compilation result for the object when it is determined that the tensor shape of the input tensor of the object is dynamic and does not exist in the shape buffer pool.

Example 2 includes the apparatus of Example 1, wherein the processor circuitry is further configured to: update the shape buffer pool by adding the compilation result for the object obtained by the JIT compilation for the object.

Example 3 includes the apparatus of Example 1 or 2, wherein the processor circuitry is further configured to: update the shape buffer pool by applying a least recently used (LRU) algorithm to remove a compilation result for an unpopular tensor shape.

Example 4 includes the apparatus of any of Examples 1 to 3, wherein the processor circuitry is further configured to run the object by use of a static tensor shape based compilation result when it is determined that the tensor shape of the input tensor of the object is static.

Example 5 includes the apparatus of any of Examples 1 to 4, wherein the compilation procedure comprises an Intermediate Representation (IR) lowering procedure based on a multi-level IR architecture for the compilation procedure.

Example 6 includes the apparatus of Example 5, wherein the IR lowering procedure comprises a shape inference pass for generating a buffer dialect from a static tensor shape based high level IR, and the buffer dialect is configured to define representations of one or more types of tensors with either static or dynamic tensor shapes, operations associated with the tensors, and attributes associated with the operations.

Example 7 includes the apparatus of Example 6, wherein the IR lowering procedure further comprises a buffer management pass configured to: set a tag for a tensor and an object associated with the tensor to indicate the tensor is dynamic and static compilation of the tensor and the associated object is not to be performed, when it is determined the tensor needs dynamic buffer according to the representation of the tensor in the buffer dialect.

Example 8 includes the apparatus of Example 6 or 7, wherein the representations of the tensors in the buffer dialect are based on a Static Single Assignment (SSA) form calculated from tensor values of the tensors.

Example 9 includes the apparatus of any of Examples 1 to 8, wherein the input tensor has a static rank.

Example 10 includes a method for a deep neural network (DNN), comprising: determining whether a tensor shape of an input tensor of an object in the DNN is dynamic and exists in a shape buffer pool, the input tensor being received from a higher network level in a compilation procedure for the DNN, the shape buffer pool being configured to store compilation results obtained by the compilation procedure for a set of predetermined tensor shapes and associated objects; running the object by use of a compilation result for the object stored in the shape buffer pool when it is determined that the tensor shape of the input tensor of the object is dynamic and exists in the shape buffer pool; and invoking the compilation procedure to perform Just-in-time (JIT) compilation for the object so as to get the compilation result for the object when it is determined that the tensor shape of the input tensor of the object is dynamic but does not exist in the shape buffer pool.

Example 11 includes the method of Example 10, further comprising: updating the shape buffer pool by adding the compilation result for the object obtained by the JIT compilation for the object.

Example 12 includes the method of Example 10 or 11, further comprising: updating the shape buffer pool by applying a least recently used (LRU) algorithm to remove a compilation result for an unpopular tensor shape.

Example 13 includes the method of any of Examples 10 to 12, further comprising: running the object by use of a static tensor shape based compilation result when it is determined that the tensor shape of the input tensor of the object is static.

Example 14 includes the method of any of Examples 10 to 13, wherein the compilation procedure comprises an Intermediate Representation (IR) lowering procedure based on a multi-level IR architecture for the compilation procedure.

Example 15 includes the method of Example 14, wherein the IR lowering procedure comprises a shape inference pass for generating a buffer dialect from a static tensor shape based high level IR, and the buffer dialect is configured to define representations of one or more types of tensors with either static or dynamic tensor shapes, operations associated with the tensors, and attributes associated with the operations.

Example 16 includes the method of Example 15, wherein the IR lowering procedure further comprises a buffer management pass configured to: set a tag for a tensor and an object associated with the tensor to indicate the tensor is dynamic and static compilation of the tensor and the associated object is not to be performed, when it is determined the tensor needs dynamic buffer according to the representation of the tensor in the buffer dialect.

Example 17 includes the method of Example 15 or 16, wherein the representations of the tensors in the buffer dialect are based on a Static Single Assignment (SSA) form calculated from tensor values of the tensors.

Example 18 includes the method of any of Examples 10 to 17, wherein the input tensor has a static rank.

Example 19 includes a computer-readable medium having instructions stored thereon, wherein the instructions, when executed by processor circuitry, cause the processor circuitry to perform the method of any of Examples 10 to 18.

Example 20 includes a device for a deep neural network (DNN), comprising means for performing the method of any of Examples 10 to 18.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. An apparatus, comprising:
interface circuitry; and
processor circuitry coupled to the interface circuitry and configured to:
determine whether a tensor shape of an input tensor of an object in a deep neural network (DNN) is dynamic and exists in a shape buffer pool, the input tensor being received via the interface circuitry from a higher network level in a compilation procedure for the DNN, the shape buffer pool being configured to store compilation results obtained by the compilation procedure for a set of predetermined tensor shapes and associated objects;
run the object by use of a compilation result for the object stored in the shape buffer pool when it is determined that the tensor shape of the input tensor of the object is dynamic and exists in the shape buffer pool; and
invoke the compilation procedure to perform Just-in-time (JIT) compilation for the object so as to get the compilation result for the object when it is determined that the tensor shape of the input tensor of the object is dynamic and does not exist in the shape buffer pool.

22. The apparatus of claim 21, wherein the processor circuitry is further configured to: update the shape buffer pool by adding the compilation result for the object obtained by the JIT compilation for the object.

23. The apparatus of claim 21, wherein the processor circuitry is further configured to: update the shape buffer pool by applying a least recently used (LRU) algorithm to remove a compilation result for an unpopular tensor shape.

24. The apparatus of claim 21, wherein the processor circuitry is further configured to run the object by use of a static tensor shape based compilation result when it is determined that the tensor shape of the input tensor of the object is static.

25. The apparatus of claim 21, wherein the compilation procedure comprises an Intermediate Representation (IR) lowering procedure based on a multi-level IR architecture for the compilation procedure.

26. The apparatus of claim 25, wherein the IR lowering procedure comprises a shape inference pass for generating a buffer dialect from a static tensor shape based high level IR, and the buffer dialect is configured to define representations of one or more types of tensors with either static or dynamic tensor shapes, operations associated with the tensors, and attributes associated with the operations.

27. The apparatus of claim 26, wherein the IR lowering procedure further comprises a buffer management pass configured to: set a tag for a tensor and an object associated with the tensor to indicate the tensor is dynamic and static compilation of the tensor and the associated object is not to be performed, when it is determined the tensor needs dynamic buffer according to the representation of the tensor in the buffer dialect.

28. The apparatus of claim 26, wherein the representations of the tensors in the buffer dialect are based on a Static Single Assignment (SSA) form calculated from tensor values of the tensors.

29. The apparatus of claim 21, wherein the input tensor has a static rank.

30. A method, comprising:
determining whether a tensor shape of an input tensor of an object in a deep neural network (DNN) is dynamic and exists in a shape buffer pool, the input tensor being received from a higher network level in a compilation procedure for the DNN, the shape buffer pool being configured to store compilation results obtained by the compilation procedure for a set of predetermined tensor shapes and associated objects;
running the object by use of a compilation result for the object stored in the shape buffer pool when it is determined that the tensor shape of the input tensor of the object is dynamic and exists in the shape buffer pool; and
invoking the compilation procedure to perform Just-in-time (JIT) compilation for the object so as to get the compilation result for the object when it is determined that the tensor shape of the input tensor of the object is dynamic but does not exist in the shape buffer pool.

31. The method of claim 30, further comprising: updating the shape buffer pool by adding the compilation result for the object obtained by the JIT compilation for the object.

32. The method of claim 30, further comprising: updating the shape buffer pool by applying a least recently used (LRU) algorithm to remove a compilation result for an unpopular tensor shape.

33. The method of claim 30, further comprising: running the object by use of a static tensor shape based compilation result when it is determined that the tensor shape of the input tensor of the object is static.

34. The method of claim 30, wherein the compilation procedure comprises an Intermediate Representation (IR) lowering procedure based on a multi-level IR architecture for the compilation procedure.

35. The method of claim 34, wherein the IR lowering procedure comprises a shape inference pass for generating a buffer dialect from a static tensor shape based high level IR, and the buffer dialect is configured to define representations of one or more types of tensors with either static or dynamic tensor shapes, operations associated with the tensors, and attributes associated with the operations.

36. The method of claim 35, wherein the IR lowering procedure further comprises a buffer management pass configured to: set a tag for a tensor and an object associated with the tensor to indicate the tensor is dynamic and static compilation of the tensor and the associated object is not to be performed, when it is determined the tensor needs dynamic buffer according to the representation of the tensor in the buffer dialect.

37. The method of claim 35, wherein the representations of the tensors in the buffer dialect are based on a Static Single Assignment (SSA) form calculated from tensor values of the tensors.

38. The method of claim 30, wherein the input tensor has a static rank.

39. A non-transitory computer-readable medium having instructions stored thereon, wherein the instructions, when executed by processor circuitry, cause the processor circuitry to perform the method of claim 30.

40. A device, comprising means for performing the method of claim 30.
